(19) United States
(12) Patent Application Publication
(10) Pub. No.: US 2004/0064210 A1
(43) Pub. Date: Apr. 1, 2004

(54) Audio driver componentization

(76) Inventors: Martin G. Puryear, Redmond, WA (US); Noel R. Cross, Seattle, WA (US); Cheng-mean Liu, Redmond, WA (US)

Correspondence Address: LEE & HAYES PLLC, 421 W RIVERSIDE AVENUE SUITE 500, SPOKANE, WA, 99201

(21) Appl. No.: 10/262,812

(22) Filed: Oct. 1, 2002

(51) Int. Cl. G05B 15/00; G06F 17/00

(52) U.S. Cl. 700/94; 700/84

(57) ABSTRACT

An audio signal processing device has input and output devices, a processor, an accelerator device in communication with the foregoing, and a memory for a storing a driver containing multiple filters of an audio filter graph. The driver controls the accelerator device. The filters contained within the driver can be executed by the accelerator device. Each filter transforms and outputs audio data in a predetermined manner. One filter mixes audio data received by the input device and another renders the mixed audio data for output by the output device. Global effect filters and acoustic cancellation filters can follow the mixing filter to, respectively, achieve a global effect on all input audio data and to cancel echoes therefrom.

### TECHNICAL FIELD

This invention generally relates to processing an audio system and, more particularly, to a driver for an audio system.

### BACKGROUND

An advanced user-defined multimedia editing system is presented in U.S. Pat. No. 5,913,038 issued to Griffiths (the “'038 patent”) which is expressly incorporated herein by reference. In the '038 patent, Griffiths teaches an application program interface which, when exposed to higher-level development applications, enables a user to graphically construct a multimedia processing project by piecing together a collection of “filters” exposed by the interface. A filter is a software module that accepts a certain type of data as input, transforms the data in some manner, and then outputs the transformed data. The collection of filters and the interface are therein respectively referred to as an audio filter graph and an audio filter graph manager. As introduced in Griffiths, an audio filter graph has three different types of filters: source filters, transform filters, and rendering filters. A source filter is used to load data from some source; a transform filter processes and passes data; and a rendering filter renders data to a hardware device or other locations (e.g., saved to a file, etc.).

A driver typically exposes a filter that has multiple Digital Signal Processor (DSP) acceleration functions, an example of which is seen in FIG. 1 where an audio stack 100A is seen. Audio stack 100A provides an example for particular discussion with respect to its use in the environment of an operating system provided by the Microsoft Corporation of Redmond, Wa., USA, such as the Windows® operating system. An audio filter graph manager 112 interfaces a plurality of higher-level application programs 102 through an interface 104 that includes one or more sets of application program interfaces (API). Interface 104 provides audio stack client functions which are seen in FIG. 1Was having an oval shape. Interface 104 can include various APIs for a group of audio playback sources as are used by operating systems offered by Microsoft Corporation, such as within the Windows® operating system environment, including WaveOut and WDMAud. These API also include Direct Sound® (DSound) which can provide hardware acceleration to the application if an underlying audio device is capable of doing so. Interface 104 is intended to represent any of a number of alternate interfaces used by operating systems to expose application program interface(s) to applications. Interface 104 provides a means by which the features of an audio filter graph 110A, to be described more fully below, are exposed to an application program 102. Audio filter graph 110A is comprised of a plurality of filters 114, and 124, and 132B/132A. An arrow 132D represents a hardware internal data pipe between mixing hardware 122B and audio rendering hardware 132C, which the software has no access to. Arrow 132D is a kind of link that is transparent to a host computing system. One of the two filters 132A, 132B are also included in audio filter graph 110A Media content is read into audio filter graph 110A from one or more source hardware 101 which can include one or more selected source files, ANV devices, antenna, etc.

Audio filter graph manager 112 controls the data structure of audio filter graph 110A and the way data moves through audio filter graph 110A The filters of audio filter graph 110A can be implemented as COM objects, each implementing one or more interfaces, and each containing a predefined set of functions, called methods. Methods are called by one of the application programs 102 or other component objects in order to communicate with the object exposing the interface. The calling application program can also call methods or interfaces exposed by the object of the audio filter graph manager 112.

Audio filter graphs work with data representing a variety of media (or non-media) data types, each type characterized by a data stream that is processed by the filter components comprising the audio filter graph. A filter positioned closer to the source of the data is referred to as an upstream filter, while those further down the processing chain is referred to as a downstream filter. For each data stream that the filter handles it exposes at least one virtual pin (i.e., distinguished from a physical pin such as one might find on an integrated circuit). A virtual pin can be implemented as a COM object that represents a point of connection for a unidirectional data stream on a filter. Input pins represent inputs and accept data into the filter, while output pins represent outputs and provide data to other filters. Each of the filters include at least one memory buffer, wherein communication of the media stream between filters is accomplished by a series of “copy” operations from one filter to another.

The filters of audio filter graph 110A can, but need not, be coupled via virtual interface pins. Individual filters can be implemented as objects to make calls to other objects for the desired input, where the pins (input and/or output) are application interface(s) designed to communicatively couple other objects (e.g., filters). For the sake of simplicity in illustration, virtual pins have been omitted from some of the filters seen in FIG. 1.

An application 102 communicates with an instance of audio rendering hardware 132C when the application 102 wants to process streaming audio media content. Audio filter graph manager 112 automatically creates audio filter graph 110A by invoking the appropriate filters. The communication of media content between filters is achieved by either (1) coupling virtual output pins of one filter to the virtual input pins of requesting filter; or (2) by scheduling object calls between appropriate filters to communicate the requested information. Audio filter graph manager 112 receives streaming data from the invoking application or an external source (not shown). It is to be appreciated that the streaming data can be obtained from a file on a disk, a network, a satellite feed, an Internet server, a video cassette recorder, or other source of media content. As used herein, the filters of audio filter graph manager 112 are intended to represent a wide variety of processing methods or applications that can be performed on media content. For example, an effect filter is selectively invoked to introduce a particular effect (e.g., 3D audio positioning reverb, audio distortion, etc.) to a media stream. One of the filters 132A, 132B provides the necessary interface to a hardware device in audio rendering hardware 132C, or other location that accepts the renderer output format, such as a memory or disk file, or a rendering device.

Audio stack 100A includes a plurality of hardware each of which is seen in FIG. 1 as a three dimensional rectangle. This hardware includes a source hardware 101, a mixing hardware 122B, and an audio rendering hardware 132C. Mixing hardware 122B, which servers the purpose of hardware accelerating the audio data stream, has a component that can mix various audio data streams. Source hardware 101 can include components for providing one or a plurality of sources of audio data streams for respective inputs to audio filter graph 110A. By way of example, source hardware 101 can include a microphone, a media player, one or more audio source files, etc.

Audio filter graph 110A is comprised of a plurality of filters, each of which is seen in FIG. 1 as a two dimensional rectangular shape. These filters include a KMixer.sys filter 114, a filter 124 which can be one or both of a Global Effects (GFX) filter and an Acoustic Echo Cancellation (AEC) filter, and one or another filter 132A, 132B which are, respectively, a Universal Serial Bus (USB) or Portclass Audio Driver without hardware mixing capability and a Universal Serial Bus (USB) or Portclass Audio Adapter Driver with mixing capability. FIG. 1 represents a choice between filter 132A that features a driver without hardware mixing and the filter 132B that features a driver with hardware mixing.

For audio stream capturing, source hardware 101 feeds data to the bottom of audio filter graph 110A to filter 132A or to filter 132B. Unidirectional data streams are output to respective output pins through memory buffers associated with the API's for the audio capture sources WaveIn/WDMAUD, and DSoundCapture. The API's for the audio capture sources WaveIn/WDMAUD and DSoundCapture in interfaces 104 result in data streams being passed to input pins at the KMixer.sys filter 114 if sample rate conversion is needed.

One or the other of two filters 132A-B in FIG. 1 can be present in audio filter graph 110A. Filter 132A is seen in phantom and filter 132B is seen in solid lines. When the filter 132A is present and filter 132B is not, due to the lack of a hardware mixing capability provided by filter 132A, no data streams are passed from audio filter graph manager 112 to filter 132A from the memory buffers associated with the API's for the audio playback source DSound-Hardware in interface 104. Conversely, when the filter 132B is present and filter 132A is not, up to three (3) data streams can be passed to respective input pins at the KMixer.sys filter 114 from memory buffers associated with the API's for the audio playback source DSound-Hardware. These three (3) data streams can be passed because of the hardware mixing capabilities with the Portclass Audio Adapter Driver for filter 132B.

KMixer.sys filter 114 linearly passes audio data streams to the filter 124. Filter 124 then linearly passes audio data streams to one or the other of filters 132A-B. The audio data streams from filter 132B are mixed by mixing hardware 122B and then rendered by audio rendering hardware 132C. Because filter 132A does not provide mixing capability, the single stream is passed directly to the audio rendering hardware 132C. For instance, hardware 132C can be connected to one or more speakers for rendering an analog waveform of the mixed audio data streams.

Filter 124, which can be a GFX filter or an AEC filter, can be one filter or plurality of filters that are connected in series. Using a GFX filter, an audio stream can be subjected to an effects algorithm for various uses, such as for speaker compensation so as to achieve a better quality sound on identified speakers. Global effects are intended to be system wide, meaning that the effects to should apply to each of multiple applications executing simultaneously, where each application produces an audio data stream. The GFX filter is intended to have an effect on output of all of the applications. The GFX filter can have the intended effect when outputting to filter 132A which is a USB Audio filter that has no hardware mixing capability. A problem exists, however, when attempting to use filter 124 to achieve a global effect because filter 124 does not have access to the final audio data stream. As such, the effect of filter 124 will be an effect that is applied to the audio data stream specific to the output of filter 114. Thus, the GFX filter, rather than providing a desired global effect, can only provide a local affect on a particular subset of audio data stream that is input to the mixing hardware 122B.

Filter 124 can be an AEC filter. The goal of an AEC filter is to remove most of an echo effect that is caused by an audio data stream that is output by one hardware component, then input into another hardware component, and then output again so as to produce an echo. By way of example, an echo might be heard where a speaker outputs a first sound simultaneous with a microphone receiving a second sound, where the microphone also picks up the first sound output from the speaker. Thus, the first sound will be output twice by the speaker to produce an echo. A problem exists, however, when filter 124 is attempted to be used to accomplish acoustic echo cancellation. Filter 124 can not cancel an echo because it lacks access to the final audio data stream that is sent to audio rendering hardware 132C for rendering. The echo is not cancelled because all of the mixed audio data streams are embedded in the monolithic driver prior to the rendering function. Once at the render stage, the audio data streams are converted to the analog domain and the opportunity is lost to cancel out a sound that is echoing due to its being input twice.

It would be an advance in the art to provide a global effect on a plurality of audio streams produced by a plurality of simultaneously executing applications. It would also be an advance in the art to provide means for acoustic echo cancellation (AEC). It would further be an advance in the art to provide means for hardware acceleration of various effects on simultaneously produced audio data streams flowing through an audio filter graph, including GFX and AEC, the end result of which is heard in an analog rendering. Accordingly, this invention arose out of needs associated with providing improved methods and systems that provide the forgoing advances in the art.

### SUMMARY

In accordance with the described embodiments, application programs interface with an audio filter graph to render analog audio output. The audio filter graph is composed of a plurality of audio filters of which some audio filters expose features of the audio hardware. The driver is componentized by re-representing a monolithic filter in a new way that exposes a combination of individual functions as separate filters. Alternatively, the driver can be componentized by exposing the driver as multiple drivers, each having the same monolithic filter that is divided into different components having respective functionalities. Each functional component can be hardware accelerated when the audio filter graph is interfaced with hardware accelerators to perform the respective functions of the respective functional components. One filter in the audio filter graph is a functional component that mixes multiple audio data streams to form a final audio data stream. Another filter in the audio filter graph is a functional component that separately renders the final audio data stream.

### BRIEF DESCRIPTION OF THE DRAWINGS

The same reference numbers are used throughout the figures to reference like components and features.

FIG. 1 is a graphical representation of a conventional audio filter graph manager in a WINDOWS® operating system environment for an audio rendering process.

FIG. 2 is a graphical representation of an audio filter graph in a WINDOWS® operating system environment for an audio rendering process incorporating teachings of a described embodiment.

FIG. 3 is a graphical representation of an audio filter graph in a WINDOWS® operating system environment for an audio rendering process incorporating teachings of a described embodiment.

FIG. 4 is a graphical representation of an audio filter graph in a WINDOWS®g operating system environment for an audio rendering process incorporating teachings of a described embodiment.

FIG. 5 is a block diagram of an exemplary computer environment in which various embodiments can be practiced.

### DETAILED DESCRIPTION

Overview

Various described embodiments include an audio filter graph manager for various application programs having application program interfaces (APIs) to an audio filter graph that communicates with various hardware. In the discussion herein, aspects of the invention are developed within the general context of computer-executable instructions, such as program modules, being executed by one or more conventional computers. Generally, program modules include routines, programs, objects, components, data structures, etc. that perform particular tasks or implement particular abstract data types. Moreover, those skilled in the art will appreciate that the invention may be practiced with other computer system configurations, including hand-held devices, personal digital assistants, multiprocessor systems, microprocessor-based or programmable consumer electronics, network PCs, minicomputers, mainframe computers, and the like. In a distributed computer environment, program modules may be located in both local and remote memory storage devices. It is noted, however, that modification to the architecture and methods described herein may well be made without deviating from spirit and scope of the present invention. Moreover, although developed within the context of an audio filter graph manager paradigm, those skilled in the art will appreciate, from the discussion to follow, that the application program interface may well be applied to other development system implementations. Thus, the audio filter graph managers described below are but a few illustrative implementations of a broader inventive concept.

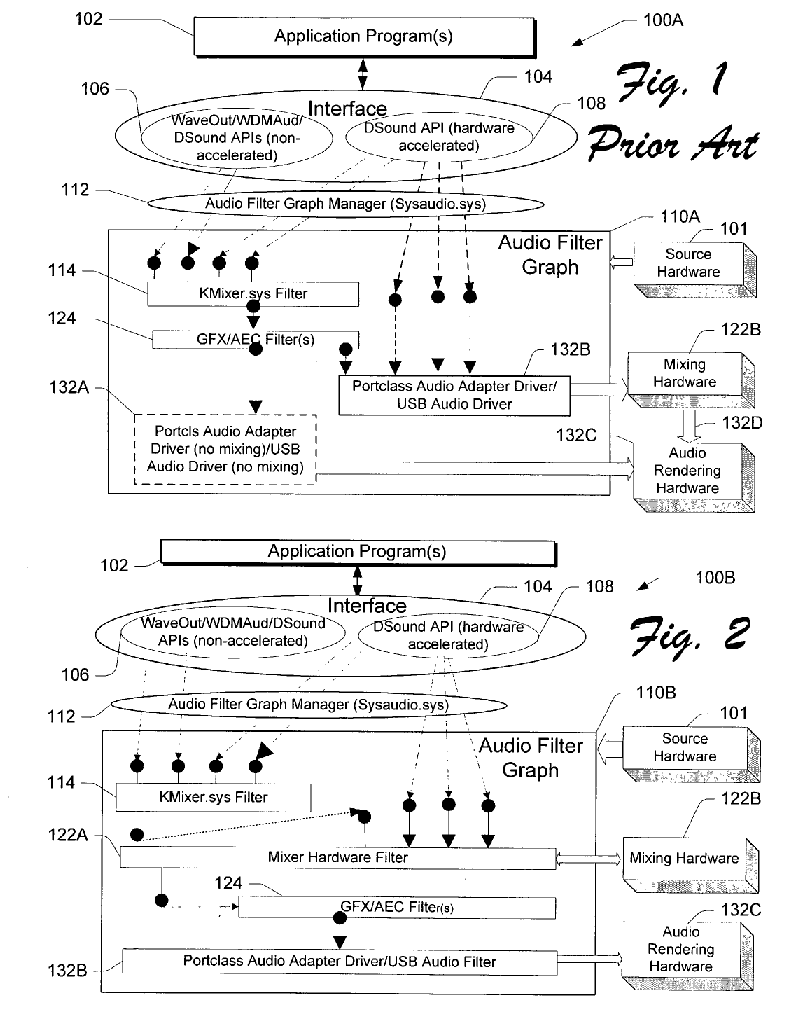

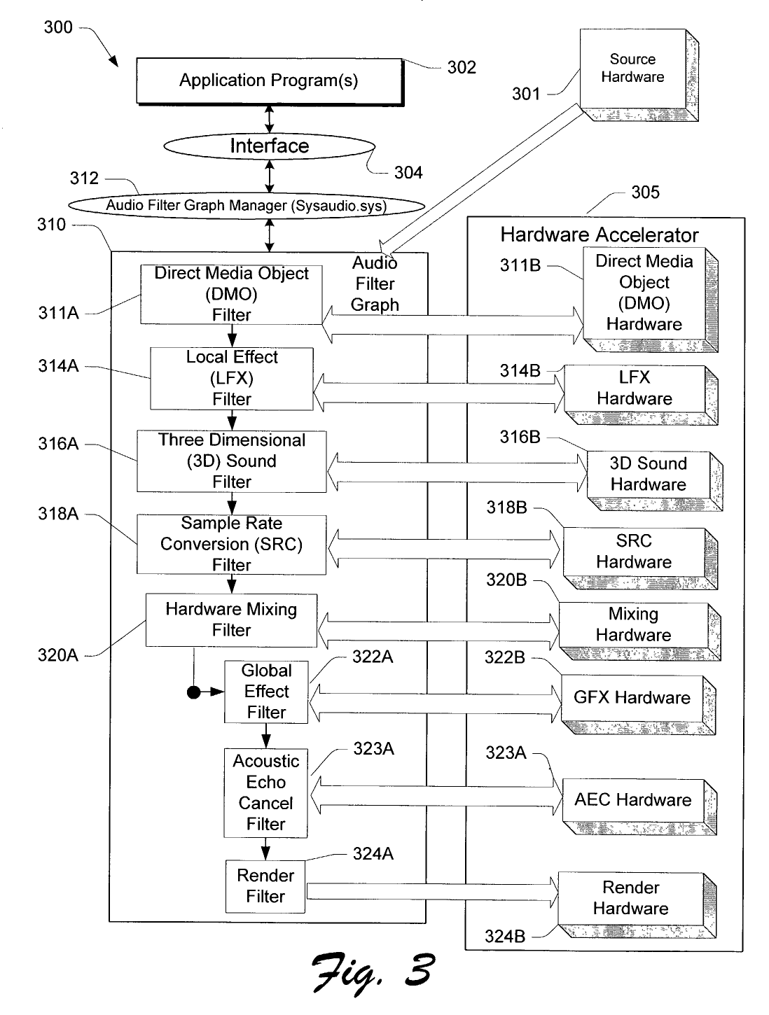

FIG. 2 shows an audio stack 100B that includes an audio filter graph manager 112 in accordance with one embodiment of the present invention. Audio stack 100B provides interface 104 to audio filter graph manager 112 and to application program(s) 102 for the processing of audio with various hardware. As used herein, application program(s) 102 are intended to represent any of a wide variety of applications which may benefit from an audio data stream processing application. Audio stack 100B differs from audio stack 100A by the presence of a mixer hardware filter 122A in communication with mixing hardware 122B. Mixer hardware filter 122A in FIG. 2 is in series between KMixer.sys filter 114 and filter 124. Unlike filter 132A-B in FIG. 1 that is in communication with both mixing hardware 122B and audio rendering hardware 132C, FIG. 2 shows a filter 132B in communication with audio rendering hardware 132C. Thus, the mixing and rendering filter functions that are combined in filters 132A-B in FIG. 1 have been separated out, respectively, into filters 122A and 132B in FIG. 2. To accomplish this separation of functions, the mixer hardware filter 122A exposes an audio data stream following acceleration by mixing hardware 122B so as to make the mixed audio data stream available for processing to accomplish various audio effects. These audio effects include three dimensional processing, reverb, and other DSP audio effects. Additionally, sounds that are input by source hardware 101 that would otherwise be echoes can be cancelled from mixed audio data streams that are output from mixer hardware filter 122A by use of an AEC function of filter 124. When audio stack 110B is to provide an audio effect, the mixer hardware filter 122A provides the ability to separate the local effects stage from the rendering stage. The local effects stage can be implemented in hardware, such as by a hardware acceleration card. As such, more value can be added to the software drivers for use with hardware accelerators at a stage that is before the mixing and rendering stage.

Mixer hardware filter 122A is seen in FIG. 2 has having four (4) virtual input pins that receive audio data streams. For simplicity in illustration, all virtual pins are not shown on all filters in FIG. 2. One (1) virtual input pin receives an audio data stream from KMixer.sys filter 114 and three (2) virtual input pins receive audio data streams from the DSound-Hardware API 108 of the interface 104. A software and hardware interface, seen in FIG. 2 as a double arrow line, provides communication between mixer hardware filter 122A and mixing hardware 122B. Following any acceleration provided by mixing hardware 122B, mixing hardware filter 122A outputs a final audio data stream to one (1) virtual output pin. The virtual output pin provides input to filter 124. When filter 124 is a GFX filter, either a hardware acceleration (not shown) or a software process can be used to provide a global effect on the final audio data stream from the virtual output pin of mixer hardware filter 122A. When filter 124 is an AEC filter, hardware acceleration need not but might be used.

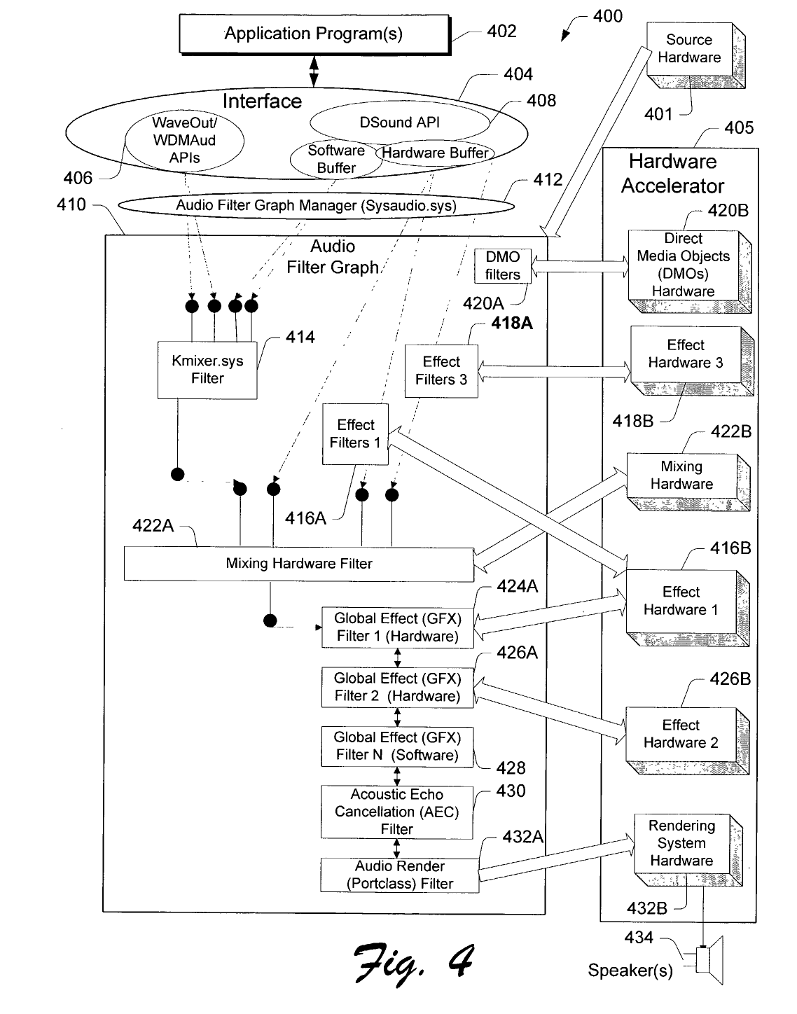

In accordance with the illustrated example embodiment of an audio stack 300 seen in FIG. 3, one or more application program(s) 302 are coupled by an interface 304 to an audio filter graph manager 312. Audio filter graph manager 312 communicates with audio filter graph 310 that receives input from source hardware 301. Hardware accelerator 305, which can be one or more audio accelerator cards, uses drivers represented in audio filter graph 310 to provide local and global effects upon audio data streams as well as cancellation of echoes due to input received from source hardware 301. Table A, below, reflects successively linear processing by a series of filters and each of their respective corresponding hardware accelerator functions.

TABLE A

| Filters | Hardware Components |
|---|---|
| DirectX Media Object (DMO) 311A | DMO 311B |
| Local Effect (LFX) 314A | LFX 314B |
| Three Dimensional (3D) Sound 316A | 3D Sound 316B |
| Sample Rate Conversion (SRC) 318A | SRC 318B |
| Hardware Mixing 320A | Mixing 320B |
| Global Effect (GFX) 322A | GFX 322B |
| Acoustic Echo Cancellation (AEC) 323A | AEC 323B |
| Render 324A | Render 324b |

Similar to FIG. 2, FIG. 3 shows the separation of the hardware mixing filter and its corresponding accelerator hardware (320A, 320B) from the render filter and its corresponding accelerator hardware (324A, 324B). As such, each of filters 322A and 323A can process the mixed final audio data stream that is output from hardware mixing filter 320A.

By providing a separate component for each driver module, acceleration hardware is able to have flexibility to partition its features into individual function units. By providing a driver model that is able to interoperate with an operating system in a coordinated way, the individual function units can be exposed for use by the users of the operating system. Each function unit, whether it's a DMO acceleration, mixing, or render, has its own filter driver to work with the operating system. As such, partitions are provided for each of the audio hardware features. For each of those partitions, a detailed interface specification can be generated for use by a user of the operating system. Each driver, as a separate component, can be a software module or hardware accelerated module. In a system that can have more than one of the same types of processing module, hardware modules are preferred over software modules so as to achieve maximum processing performance due to less Central Processing Unit (CPU) consumption. Additionally, hardware and software modules can be made to be exchangeable one with another. In the WINDOWS® operating system environment, the separated driver components can be in the form of a Kernel Stream (KS) filter.

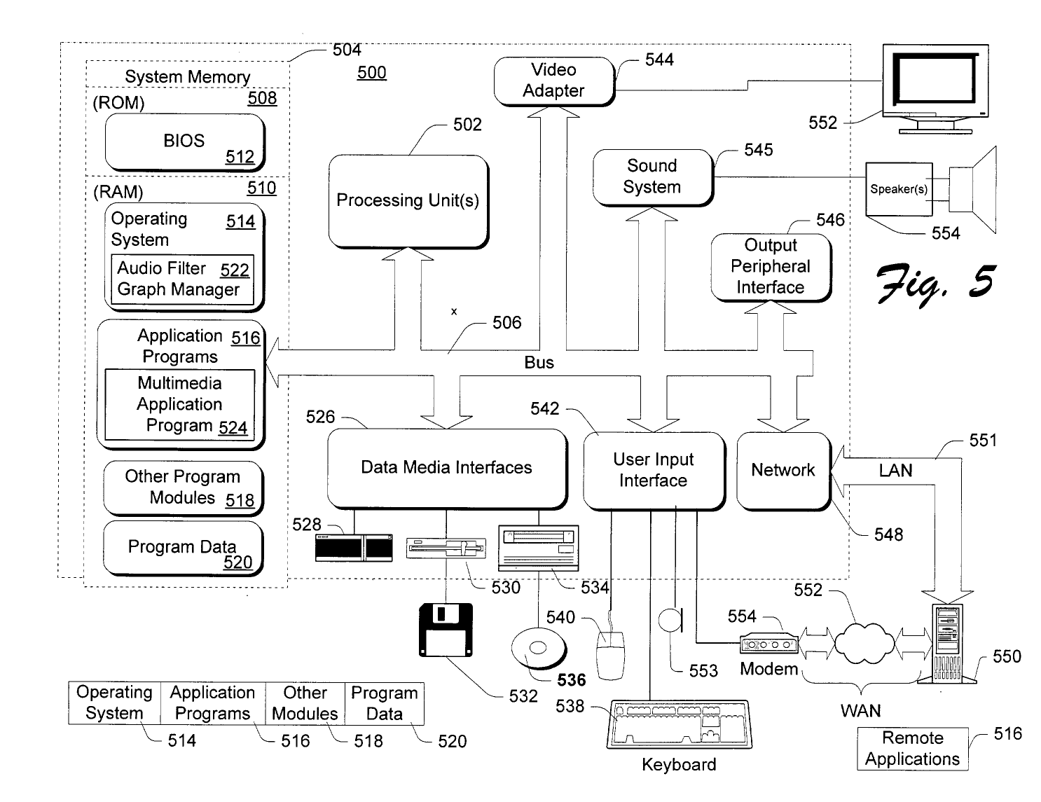

FIG. 4 shows an audio stack 400 in accordance with one embodiment of the present invention. Audio stack 400 is particularly suited for an operating system environment provided by the Microsoft Corporation, such as the WINDOWS® operating system. Audio stack 400 provides an interface 404 to an audio filter graph manager 412. Audio filter graph manager 412 communicates with an audio filter graph 410 and to application program(s) 402 through interface 402 for the processing of audio with various hardware in one or more hardware accelerator cards 405. As used herein, application program(s) 402 are intended to represent any of a wide variety of applications which may benefit from an audio data stream processing application. Audio stack 400 has various filters linearly arranged and situated prior to a mixer hardware filter 422A.

Table B, below, reflects successively linear processing by a series of filters represented in FIG. 4 and, where applicable, each of their respective corresponding hardware accelerator functions:

TABLE B

| Filters | Hardware Components |
|---|---|
| Audio Filter Graph Manager 412 | — |
| KMixer.sys 414 | — |
| DirectX Media Object (DMO) 420A | DMO Hardware 420B |
| Local Effect Filters 1 416A | Effect Hardware 1 416B |
| Local Effect Filters 3 418A | Effect Hardware 3 418B |
| Global Effect (GFX) Filter 1 (Hardware) 424A | Effect Hardware 1 416B |
| Global Effect (GFX) Filter 2 (Hardware) 426A | Effect Hardware 2 426B |
| Global Effect (GFX) Filter N (Software) 428 | — |
| Hardware Mixing 422A | Mixing Hardware 422B |
| Acoustic Echo Cancellation (ABC) 430 | — |
| Audio Render (Portclass) 432A | Render System |
| | Hardware 432B |

In the illustrated implementation of FIG. 4, the following filters do not have corresponding hardware accelerator components: KMixer.sys 414, Global Effect (GFX) Filter N (Software) 428, and Acoustic Echo Cancellation (AEC) 430. Interface 404 has a DSound API 408 that features both software and hardware buffers. The software buffer of DSound API 408 interfaces with audio filter graph manager 412 to provide an audio data stream to two (2) virtual input pins of KMixer.sys filter 414. The hardware buffer of DSound API 408 interfaces with audio filter graph manager 412 to provide an audio data stream to one (1) virtual input pin of Mixing Hardware filter 422A. The hardware buffer of DSound API 408 interfaces with Local Effect Filters 1 416A to provide an audio data stream to another virtual input pin of Mixing Hardware filter 422A. The hardware buffer of DSound API 408 interfaces with Local Effect Filters 3 418A to provide an audio data stream to another virtual input pin of Mixing Hardware filter 422A. When the DMO filter 420A is a user-mode accessible COM object, DSound API 408 can interface with a DMO filter 420A to be accelerated by DMO Hardware 420B. For simplicity of illustration, some of the virtual pins on some of the filters are not shown.

Similar to FIGS. 2 and 3, FIG. 4 shows the separation of the hardware mixing filter and its corresponding accelerator hardware (422A, 422B) from the render filter and its corresponding accelerator hardware (432A, 432B). As such, one (1) virtual output pin from mixing hardware filter 422A provides the final audio data stream as an input to filter 424A. Filter 424A is the first in a linear series of other filters (426A, 428, and 430). In one implementation, more than one GFX filter can be connected together. In may be preferred that the GFX filters be applied prior to the AEC filter for global effect processing. Depending on where a GFX filter is positioned in an audio filter graph, it could become a local effect if it's used in the local stream (pre-mixer) or a GFX filter if it's applied on the mixed stream. Sometimes there could be two instances of an effects filter, where one works as a GFX filter while the other plays as a local effect filter. After the mixed final audio data stream is processed by Audio Render (Portclass) filter 432A and its corresponding Rendering System Hardware 432B, one or more speakers 434 can then render therefrom an analog version of the final audio data stream.

FIG. 4 shows that mixing hardware filter 422A has a virtual input pin that is reserved to receive an audio data stream from a virtual output pin of KMixer.sys filter 414. The audio data stream sources received by the KMixer.sys filter 414 are either from the legacy audio Application Program Interfaces (APIs) WaveOut/WDMAud 406 or from non-accelerated API audio data streams of DSound API 408. All the other virtual input pins of mixing hardware filter 422A are used to accommodate either the DSound API 408 from its hardware buffer or the hardware accelerated audio data streams from Effect Filters 1 and 3 (416A, 418A). The main task of mixing hardware filter 422A is to feed all the data on its virtual input pins to other filters that will, in turn, have their respective audio data streams hardware accelerated. Then, mixing hardware filter 422A directs hardware to mix the processed audio data streams. The mixed audio data streams are then buss-mastered back to memory in the host for further preparation for processing down audio filter graph 410.

In an implementation, it can be advantageous to accelerate the processing of audio data streams by making separate components for hardware drivers. The user can select among the different hardware according to those functions that the respective hardware best provides. For instance, a computing system may have two (2) different accelerator boards, each of which is superior to the other in a particular function. As such, the user can select use of a particular driver component so as to control the respective hardware accelerator board selected and thereby accomplish the superior function that hardware accelerator board. In one implementation, an apparatus has a plurality of digital signal processors (DSP) in communication with a host processor. Each DSP is included in a separate piece of hardware, such as an accelerator card that is manufactured by a different manufacturer (e.g. (i) Creative Labs, Inc. of Milpitas, Calif., USA, (ii) Nvidia, Inc. of Santa Clara, Calif., USA, (iii) etc.). The host processor can be included in a personal computer. The host processor executes a driver that has a plurality of driver components. Each driver component has an instruction set executable by a respective DSP to transform an audio data stream in a predetermined manner that is different from that of the other driver components. The apparatus also has audio input and output devices for inputting and outputting audio data streams.

In another implementation, upon execution of an instruction set of a driver component by one of the DSPs, audio data streams that are received by the audio input device arc mixed together. Then, upon execution of another instruction set of another driver component by another DSP, the mixed audio data streams are rendered in an analog form for output by the audio output device. In still another implementation, upon execution of an instruction set of one of the driver component by one of the DSPs, the mixed audio data streams are transformed in a predetermined manner. This predetermined manner can be a predetermined global effect that is made on the mixed audio data streams, or it can be the removal of a portion of the mixed audio data streams that would otherwise cause an echo in the analog form rendering output by the audio output device.

Exemplary Computer Environment

The embodiments described above can be implemented in connection with any suitable computer environment. Aspects of the various embodiments can, for example, be implemented, in connection with server computers, client computers/devices, or both server computers and client computers/devices. As but one example describing certain components of an exemplary computing environment, consider FIG. 5.

FIG. 5 illustrates an example of a suitable computing system 500 on which the system and related methods for processing media content may be implemented.

It is to be appreciated that computing system 500 is only one example of a suitable computing environment and is not intended to suggest any limitation as to the scope of use or functionality of the media processing system. Neither should the computing system 500 be interpreted as having any dependency or requirement relating to any one or combination of components illustrated in the exemplary computing environment 500.

The media processing system is operational with numerous other general purpose or special purpose computing system environments or configurations. Examples of well known computing systems, environments, and/or configurations that may be suitable for use with the media processing system include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

In certain implementations, the system and related methods for processing media content may well be described in the general context of computer-executable instructions, such as program modules, being executed by a computer. Generally, program modules include routines, programs, objects, components, data structures, etc. that perform particular tasks or implement particular abstract data types. The media processing system may also be practiced in distributed computing environments where tasks are performed by remote processing devices that are linked through a communications network. In a distributed computing environment, program modules may be located in both local and remote computer storage media including memory storage devices.

In accordance with the illustrated example embodiment of FIG. 5 computing system 500 is shown comprising one or more processors or processing units 502, a system memory 504, and a bus 506 that couples various system components including the system memory 504 to the processor 502.

Bus 506 is intended to represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) buss also known as Mezzanine bus.

Computing system 500 typically includes a variety of computer readable media. Such media may be any available media that is locally and/or remotely accessible by computing system 500, and it includes both volatile and non-volatile media, removable and non-removable media.

In FIG. 5, the system memory 504 includes computer readable media in the form of volatile, such as random access memory (RAM) 510, and/or non-volatile memory, such as read only memory (ROM) 508. A basic input/output system (BIOS) 512, containing the basic routines that help to transfer information between elements within computing system 500, such as during start-up, is stored in ROM 508. RAM 510 typically contains data and/or program modules that are immediately accessible to and/or presently be operated on by processing unit(s) 502.

Computing system 500 may further include other removable/non-removable, volatile/non-volatile computer storage media. By way of example only, FIG. 5 illustrates a hard disk drive 528 for reading from and writing to a non-removable, non-volatile magnetic media (not shown and typically called a “hard drive”), a magnetic disk drive 530 for reading from and writing to a removable, non-volatile magnetic disk 532 (e.g., a “floppy disk”), and an optical disk drive 534 for reading from or writing to a removable, non-volatile optical disk 536 such as a CD-ROM, DVD-ROM or other optical media. The hard disk drive 528, magnetic disk drive 530, and optical disk drive 534 are each connected to bus 506 by one or more interfaces 526.

The drives and their associated computer-readable media provide nonvolatile storage of computer readable instructions, data structures, program modules, and other data for computing system 500. Although the exemplary environment described herein employs a hard disk 528, a removable magnetic disk 532 and a removable optical disk 536, it should be appreciated by those skilled in the art that other types of computer readable media which can store data that is accessible by a computer, such as magnetic cassettes, flash memory cards, digital video disks, random access memories (RAMs), read only memories (ROM), and the like, may also be used in the exemplary operating environment.

A number of program modules may be stored on the hard disk 528, magnetic disk 532, optical disk 536, ROM 508, or RAM 510, including, by way of example, and not limitation, an operating system 514, one or more application programs 516 (e.g., multimedia application program 524), other program modules 518, and program data 250. In accordance with the illustrated example embodiment of FIG. 5, operating system 514 includes an application program interface embodied as a render engine 522. As will be developed more fully below, render engine 522 is exposed to higher-level applications (e.g., 516) to automatically assemble audio filter graphs in support of user-defined development projects, e.g., media processing projects. Unlike conventional media processing systems, however, render engine 522 utilizes a scalable, dynamically reconfigurable matrix switch to reduce audio filter graph complexity, thereby reducing the computational and memory resources required to complete a development project. Various aspects of the innovative media processing system represented by a computing system 500 implementing the innovative render engine 522 will be developed further, below.

Continuing with FIG. 5, a user may enter commands and information into computing system 500 through input devices such as keyboard 538 and pointing device 540 (such as a “mouse”). Other input devices may include an audio/video input device(s) such as one or more microphones 553, and/or a joystick, game pad, satellite dish, serial port, scanner, or the like (not shown). These and other input devices are connected to the processing unit(s) 502 through input interface(s) 542 that is coupled to bus 506, but may be connected by other interface and bus structures, such as a parallel port, game port, or a universal serial bus (USB).

A monitor 552 or other type of display device is also connected to bus 506 via an interface, such as a video adapter 544. In addition to the monitor, personal computers typically include other peripheral output devices (not shown), such as printers and image projectors, which may be connected through output peripheral interface 546. A sound system 545, which may include audio acceleration hardware, is connected to bus 506 and outputs to one or more speakers 554.

Computing system 500 may operate in a networked environment using logical connections to one or more remote computers, such as a remote computer 550. Remote computer 550 may include many or all of the elements and features described herein relative to computing system 500 including, for example, a audio filter graph manager 522 and one or more development applications 516 utilizing the resources of audio filter graph manager 522.

As shown in FIG. 5, computing system 500 is communicatively coupled to remote devices (e.g., remote computer 550) through a local area network (LAN) 551 and a general wide area network (WAN) 552. Such networking environments are commonplace in offices, enterprise-wide computer networks, intranets, and the Internet.

When used in a LAN networking environment, the computing system 500 is connected to LAN 551 through a suitable network interface or adapter 548. When used in a WAN networking environment, the computing system 500 typically includes a modem 554 or other means for establishing communications over the WAN 552. The modem 554, which may be internal or external, may be connected to the system bus 506 via the user input interface 542, or other appropriate mechanism.

In a networked environment, program modules depicted relative to the personal computing system 500, or portions thereof, may be stored in a remote memory storage device. By way of example, and not limitation, FIG. 5 illustrates remote application programs 516 as residing on a memory device of remote computer 550. It will be appreciated that the network connections shown and described are exemplary and other means of establishing a communications link between the computers may be used.

Conclusion

Compared to other approaches, the inventive approach described above has more satisfactory results because there is one filter to control each corresponding hardware function partition unit. By making each driver a separate component, acceleration can be done in any stage of the audio processing as long as a corresponding hardware feature exists. The driver can be interchangeable as either a hardware or a software implementation. Additionally, the function of mixing audio data streams can be separately accelerated by hardware.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

What is claimed is:

1. An apparatus comprising an audio filter graph for processing an audio data stream through driver components that separately control a plurality of transformations of the audio data stream.

2. The apparatus as defined in claim 1, further comprising a plurality of application programs interfaced through a plurality of application program interfaces to an audio filter graph manager in communication with the audio filter graph.

3. The apparatus as defined in claim 1, further comprising a respective hardware accelerator for each of the transformations of the audio data stream.

4. An audio filter graph comprising a mixing driver component separate from a render driver component for respectively mixing audio data streams and rendering the mixed audio data streams.

5. The audio filter graph as defined in claim 4, further comprising:
an input from source hardware;
an interface from the mixing driver component with mixing hardware; and
an output from the render driver component to audio rendering hardware.

6. An audio filter graph comprising:
a mixing filter that transforms multiple audio data streams into a final audio data stream that includes a mixture of the multiple audio data streams; and
a rendering filter that transforms the final audio data stream into a rendering of an analog version thereof.

7. The audio filter graph as defined in claim 6, wherein:
the mixing filter makes each of the multiple audio streams available to a hardware accelerator for transformation of the multiple audio streams into the final audio data stream; and
the rendering filter makes the final audio data stream available to a hardware accelerator for transformation into the analog version of the final audio data stream.

8. The audio filter graph as defined in claim 6, further comprising:
an input from source hardware;
an interface from the mixing filter with mixing hardware; and
an output from the render filter to audio rendering hardware.

9. An audio filter graph comprising driver components each separately controlling an acceleration of a transformation of an audio data stream.

10. The audio filter graph as defined in claim 9, wherein the driver components include:
a mixing accelerated transformation of separate digital audio data streams into a digital mixed audio data stream; and
a digital-to-audio transformation of the digital mixed audio data stream to an analog rendering thereof.

11. The audio filter graph as defined in claim 9, further comprising:
an input from source hardware;
an interface with mixing hardware for the mixing accelerated transformation; and
an output for the analog rendering to audio rendering hardware.

12. A method comprising exposing a monolithic filter as separate filters, each being a component having its own functionality, wherein the monolithic filter represents a combined functionality of all of the separate filters.

13. The method as defined in claim 12, the filters are selected from the group consisting of:
a filter that mixes multiple audio data streams to form a final audio data stream;
a filter that receives and transforms the final audio data stream so as to output an audio data stream having a predetermined global effect on all of the mixed multiple audio data streams; and
a filter that receives and transforms the audio data stream having the predetermined global effect so as to remove a portion thereof that can cause an echo in a rendering thereof; and
a filter that renders the final audio data stream;

14. The method as defined in claim 13, further comprising hardware accelerating the functionality of each said filter.

15. A method comprising:
exposing a driver containing a monolithic filter as multiple drivers, wherein each of the multiple drivers has a separate functional aspect of the monolithic filter; and
hardware accelerating each functional aspect of the monolithic filter.

16. The method as defined in claim 15, wherein the functional aspects of the monolithic filter are selected from the group consisting of:
a functional component that mixes multiple audio data streams to form a final audio data stream;
a functional component that receives and transforms the final audio data stream so as to output an audio data stream having a predetermined global effect on all of the mixed multiple audio data streams; and
a functional component that receives and transforms the audio data stream having the predetermined global effect so as to remove a portion thereof that can cause an echo in a rendering thereof; and
a functional component that renders the final audio data stream;

17. A computer readable medium having computer instructions thereon that, when executed by a computer, performs the method of claim 15.

18. A computing device comprising:
a host computer;
a digital signal processor (DSP);
a memory to store:
a driver which, when executed by the host computer, controls the DSP;
an audio filter graph including a plurality of filters each being executable, in full or in part, by the host computer or the DSP to:
receive an audio data stream;
make the received audio data stream available for transformation; and
transform, in a predetermined manner, the audio data stream made available;
an application program which, when executed by the host computer, interfaces with the audio filter graph to output a rendering of the transformed audio data stream.

19. An audio signal processing device comprising:.
audio input and output devices;
a plurality of digital signal processors (DSP) in communication with the audio input and output devices;
a memory to store a driver containing a plurality of filters each containing an instruction set that is executable by a respective said DSP to receive and transform an audio data stream in a predetermined manner.

20. The audio signal processing device as defined in claim 19, wherein, upon execution of the corresponding instruction set:
one said filter mixes a plurality of audio data streams received by the audio input device to output a mixed audio data stream;
another said filter receives and transforms the mixed audio data stream so as to output an audio data stream having a predetermined global effect;
another said filter receives and transforms the audio data stream having the predetermined global effect so as to remove a portion thereof that can cause an echo in a rendering thereof, and
another said filter renders the audio data stream having the predetermined global effect for output by the audio output device.

21. An audio signal processing device comprising:
an audio signal input device;
an audio signal output device;
a processor;
an accelerator device, in communication with the audio signal input device, the processor, and the audio signal output device, for processing audio signals; and
a memory for storing a driver program including a plurality of filters each of which, when executed by the processor, controls the accelerator device, wherein:
each said filter has an instruction set which, when executed, receives an audio data stream, transforms the audio data stream in a predetermined manner, and then outputs the transformed audio data stream;
the instruction set of each said filter is executed by either the processor or the accelerator device;
a mixing filter of the plurality of filters mixes a plurality of audio data streams received by the audio input device and outputs the mixed plurality of audio data streams; and
a rendering filter of said plurality of filters renders the mixed plurality of audio data streams for output by the audio output device.

22. The audio signal processing device as defined in claim 21, wherein the plurality of filters further comprises:
a global effect filter to receive and transform a final stream of audio signals from the mixing filter so as to output an audio data stream having a predetermined global effect on all of the final stream of audio signals from the mixing filter; and
an acoustic echo cancellation filter to receive and transform the output from the global effect filter so as to remove a portion thereof that can cause an echo in a rendering thereof.

23. An apparatus comprising a host processor in communication with a plurality of digital signal processors (DSP), wherein:
the host processor executes a driver;
the driver has a plurality of driver components; and
each said driver component has an instruction set executable by a respective said DSP to transform an audio data stream in a predetermined manner different from that of the other said driver components.

24. The apparatus as defined in claim 23, further comprising a plurality of application programs executable by the host computer and interfaced through a plurality of application program interfaces to an audio filter graph manager in communication with an audio filter graph containing the driver components.

25. The apparatus as defined in claim 23, wherein the plurality of driver components corresponds to a plurality of filters.

26. The apparatus as defined in claim 23, further comprising audio input and output devices for respectively inputting and outputting audio data streams, wherein:
upon execution of an instruction set of a driver component by one said DSP, audio data streams received by the audio input device are mixed together; and
upon execution of an instruction set of a driver component by another said DSP, the mixed audio data streams are rendered in an analog form for output by the audio output device.

27. The apparatus as defined in claim 26, wherein upon execution of an instruction set of a driver component by another said DSP, the mixed audio data streams are transformed in a predetermined manner selected from the group consisting of:
a predetermined global effect is made on the mixed audio data streams; and
a portion of the mixed audio data streams is removed that would otherwise cause an echo in the analog form rendering output by the audio output device.

28. The apparatus as defined in claim 23, wherein:
the host processor is included in a personal computer; and
each said DSP is included in an accelerator card different from that of the other DSPs.

29. The apparatus as defined in claim 28, wherein the accelerator cards are made by different manufacturers.
